(19) United States
(12) Patent Application Publication
(10) Pub. No.: US 2023/0249128 A1
(43) Pub. Date: Aug. 10, 2023

(54) FLUORORESIN MEMBRANE MATERIAL AND PRODUCTION PROCESS THEREFOR

(71) Applicant: TAIYO KOGYO CORPORATION, Osaka (JP)

(72) Inventor: Kazuhiro Abe, Osaka (JP)

(21) Appl. No.: 18/299,755

(22) Filed: Apr. 13, 2023

Related U.S. Application Data
(62) Division of application No. 16/327,619, filed on May 13, 2019.

(30) Foreign Application Priority Data
Aug. 26, 2016 (JP) 2016165705

(51) Int. Cl. B01D 53/86; C08K 3/013; B01D 71/36; B01J 21/06; B01J 27/232; B01J 35/02; B01J 37/02; B01J 37/08; C08K 3/22; C08L 27/18; B01J 31/38; B32B 27/20; B32B 27/30; B32B 27/18; C08J 7/043

(52) U.S. Cl. CPC B01D 53/86; C08K 3/013; B01D 71/36; B01J 21/063; B01J 27/232; B01J 35/02; B01J 37/02; B01J 37/08; C08K 3/22; C08L 27/18; B01J 31/38; B32B 27/20; B32B 27/30; B32B 27/18; C08J 7/043; C08K 2003/2241; Y02C 20/30

(57) ABSTRACT

The following phenomenon occurring in a fluororesin membrane material using, as its main material, a PTFE having a photocatalyst layer on a surface thereof is prevented: the surface of the membrane material is contaminated after the lapse of some years from the start of its use. A photocatalyst layer arranged on the PTFE layer of a Type A membrane material is formed of a photocatalyst and fluororesins, and the fluororesins are formed of at least one of a FEP or a PFA, and a PTFE. Here, the amount of the PTFE is preferably larger than that of at least one of the FEP or the PFA, and the weight of the photocatalyst is preferably 40% or less with respect to the total weight of the photocatalyst and the fluororesins.

### CROSS-REFERENCE TO RELATED APPLICATION(S)

This is a division of U.S. application Ser. No. 16/327,619, filed Feb. 22, 2019 (U.S. Patent Application Publication No. US2019/0308142A1, published Oct. 10, 2019), which is a national stage application of International Patent Application No. PCT/JP2017/026262, filed Jul. 20, 2017, both of which are herein incorporated by reference in their entirety.

### TECHNICAL FIELD

The present document relates to a fluororesin membrane material and a method of producing a fluororesin membrane material.

### BACKGROUND ART

A fluororesin membrane material containing a fluororesin as a main material is present among membrane materials to be used as building materials for forming, for example, membrane structures. The fluororesin membrane material has been widely spreading because of, for example, the following reasons. The membrane material can form a smooth curved surface unlike a plate having high rigidity and the like, and can impart some degree of translucency to the curved surface as required. In other words, one large reason why such membrane material becomes widespread is superiority concerning its beauty.

There are various fluororesin membrane materials, and one of the membrane materials is a membrane material having a glass fiber base material produced by weaving glass fibers in which at least one surface of the base material is coated with a polytetrafluoroethylene (PTFE) that is one kind of fluororesin.

Such fluororesin membrane material formed of the combination of the glass fiber base material and the PTFE is excellent from the viewpoints of incombustibility and durability, and is classified as a Type A membrane material by the Building Standards Act in Japan. Such Type A membrane material is defined as a membrane material that can be used in the roof of architecture in the Building Standards Act, and has been applied to, for example, the roofs of large dome-shaped structures, such as a ball game ground and an athletic field.

In Japan, the fluororesin membrane material classified as a Type A membrane material, which uses the combination of the glass fiber base material and the PTFE as its basic structure, has been frequently used as described above. In addition, products equivalent to the Type A membrane material have been frequently used outside Japan.

Incidentally, the fluororesin membrane material is frequently used in architectural applications as described above. There is a need to cut the fluororesin membrane material into a predetermined shape and then to join cut parts, and the joining is generally performed by thermal welding. The PTFE is unsuitable for the thermal welding because the PTFE has a high melting point and has a high viscosity when melted. Accordingly, the arrangement of a FEP, which has a melting point lower than that of the PTFE and has a low melt viscosity, on at least one surface of the fluororesin membrane material enables the thermal welding of the fluororesin membrane materials to be easily and reliably performed.

In addition, the fluororesin membrane material can maintain its beauty for a relatively long time period because of a characteristic of its fluororesin, that is, the difficulty with which the fluororesin is contaminated. However, when the fluororesin membrane material is used outdoors, the adhesion of dirt to its surface is inevitable. For the purpose of decomposing and removing such dirt through the self-cleaning function of a photocatalyst that is typically powdery titanium oxide, the arrangement of a photocatalyst layer on at least one surface of the fluororesin membrane material has been frequently performed.

Fortunately, in Japanese classification, as long as the fluororesin membrane material uses the combination of the glass fiber base material and the PTFE as its main structure, there is considered to be no influence on the fact that the membrane material is a Type A membrane material even when a filler using, for example, glass beads as its material is added to the PTFE layer, or a layer containing any other resin, such as a tetrafluoroethylene-hexafluoropropylene copolymer (FEP), or a photocatalyst is arranged on the surface of the PTFE layer.

In view of the foregoing, in Japanese fluororesin membrane materials, a fluororesin membrane material in which a photocatalyst layer containing a FEP as a fluororesin and also containing a photocatalyst is formed on at least one surface of a PTFE layer has been put into practical use, and achieves both the enablement of easy and reliable performance of its thermal welding, and long-term maintenance of its beauty through a self-cleaning function.

### SUMMARY

### Technical Problem

However, the inventor of the present application has found that, when the fluororesin membrane material in which the photocatalyst layer containing the FEP as a fluororesin and also containing the photocatalyst is formed on at least one surface of the PTFE layer is used outdoors, after the lapse of some years, typically 5 or 6 years, a phenomenon in which the surface of the fluororesin membrane material is contaminated is frequently observed.

The present embodiments may provide a technology for preventing the following phenomenon occurring in a fluororesin membrane material using, as its main material, a PTFE having a photocatalyst layer on a surface thereof: the surface of the membrane material is contaminated after the lapse of some years from the start of its use.

### Solution to Problem

The inventor of the present application has made extensive investigations to achieve the above-mentioned technology. As a result, the inventor has found that a cause for the above-mentioned contamination is the proliferation of biological dirt, such as an alga or a fungus, in a fine crack occurring in the surface of the photocatalyst layer.

As described above, in many cases, a fluororesin in the photocatalyst layer is a FEP for facilitating the thermal welding of the fluororesin membrane materials. The FEP serves as a cause for the occurrence of a crack in the surface of the photocatalyst layer. The photocatalyst layer is generally formed by: applying a dispersion containing the FEP serving as a fluororesin and a photocatalyst to the outermost surface of a fluororesin layer; and heating and calcining the layer at a temperature equal to or more than the melting point of the FEP. The FEP is melted once at the time of the heating and calcination, and is then cured (solidified) in the process of being cooled to room temperature. Here, the FEP has a melt viscosity different from that of the PTFE, and hence the crack occurs in the surface of the FEP in the cooling process. However, the occurrence of such crack has not been necessarily considered to be a bad thing. Rather, a situation in which the following thought can be even said to be dominant has heretofore been established: the occurrence of the crack increases the surface area of the powdery photocatalyst carried on the FEP in contact with the outside, and hence the occurrence of the crack in the surface of the photocatalyst layer is preferred for causing the photocatalyst layer to exhibit a photocatalytic function, such as a self-cleaning function, more satisfactorily.

Meanwhile, the inventor of the present application has considered that one cause for the occurrence of such crack as described above is to use the FEP, which is a fluororesin having a melt viscosity different from that of the PTFE forming the PTFE layer, as a fluororesin forming the photocatalyst layer, and hence the use of the PTFE as a fluororesin forming the photocatalyst layer instead of the FEP may be able to suppress the occurrence of such crack as described above, and by extension, suppress the occurrence of an alga resulting from the presence of the crack.

However, as described above, the PTFE has a large melt viscosity (in other words, is poor in fluidity when melted), and hence tends to require long time for thermal welding to result in poor efficiency. Accordingly, in order that a fluororesin membrane material may be made practical enough to be thermally welded to any other fluororesin membrane material, it is not sufficient to use only the PTFE as a fluororesin forming its photocatalyst layer. In view of the foregoing, the inventor of the present application has used both the PTFE and the FEP as resins forming a photocatalyst layer, and has made investigations on what kinds of properties the photocatalyst layer or a fluororesin membrane material including the photocatalyst layer has in this case.

The present embodiments have been obtained as a result of such investigations.

According to one embodiment, there is provided a fluororesin membrane material, including: a fluororesin layer containing a PTFE as a fluororesin; and a photocatalyst layer arranged on at least one outermost surface of the fluororesin layer, the photocatalyst layer containing a photocatalyst and fluororesins.

In addition, in the fluororesin membrane material, the photocatalyst and the fluororesins in the photocatalyst layer satisfy a photocatalyst ratio, which is a ratio of a weight of the photocatalyst to a total weight of the photocatalyst and the fluororesins, of 40% or less. In addition, in the fluororesin membrane material, the fluororesins in the photocatalyst layer are formed of a specific fluororesin that is a fluorinated resin copolymer having a melting point of 240° C. or more and a continuous use temperature of 200° C. or more, and the PTFE, and the specific fluororesin and the PTFE in the photocatalyst layer satisfy a specific fluororesin ratio, which is a ratio of a weight of the specific fluororesin to a total weight of the specific fluororesin and the PTFE, of 50% or less.

The fluororesin membrane material of the present application includes the fluororesin layer as in a related-art fluororesin membrane material, such as a Type A membrane material in Japan. In addition, the fluororesin membrane material of the present application includes the photocatalyst layer on at least one surface of the fluororesin layer.

Here, as a result of the above-mentioned investigations, the PTFE, and the specific fluororesin that is a fluorinated resin copolymer having a melting point of 240° C. or more and a continuous use temperature of 200° C. or more are used as the fluororesins in the photocatalyst layer in the fluororesin membrane material of the present application. In the present application, the occurrence of a crack in the photocatalyst layer is suppressed by selecting the same PTFE as the component forming the PTFE layer arranged on the surface of the photocatalyst layer as a fluororesin forming the photocatalyst layer. Meanwhile, when only the PTFE is used as a fluororesin in the photocatalyst layer, the thermal welding of the fluororesin membrane materials may require long time to result in poor efficiency. Accordingly, in the present application, the occurrence of such inconvenience is suppressed by incorporating the specific fluororesin that is a fluorinated resin copolymer having a melting point of 240° C. or more and a continuous use temperature of 200° C. or more into the photocatalyst layer in addition to the PTFE. As described above, one cause for the occurrence of a crack in a photocatalyst layer in the related-art fluororesin membrane material is a difference in melt viscosity between the FEP in the photocatalyst layer and the PTFE in the PTFE layer below the photocatalyst layer. Therefore, as the amount of the FEP to be mixed into the photocatalyst layer increases, the crack occurs in the photocatalyst layer. When the specific fluororesin ratio, which is the ratio of the weight of the specific fluororesin to the total weight of the specific fluororesin and the PTFE in the photocatalyst layer, is set to 50% or less, no crack is present, or even if a crack is present, the crack occurring in the photocatalyst layer of the fluororesin membrane material of the present application is brought into a state of being significantly suppressed as compared to at least the crack occurring in the photocatalyst layer of the related-art fluororesin membrane material, though it cannot be said that such crack is completely prevented from occurring. Although it has been described that the photocatalyst layer described in the “Background Art” section contains only the FEP as a fluororesin, the inventor of the present application has confirmed that the effects of the present embodiments are obtained even when the PTFE is added to a product obtained by replacing part or the entirety of the FEP with a PFA. It should be noted that the fluororesin except the PTFE forming the photocatalyst layer in the present embodiments is not limited to the FEP, and only needs to be a specific fluororesin that is a fluorinated resin copolymer having a melting point of 240° C. or more and a continuous use temperature of 200° C. or more. The specific fluororesin may be, for example, at least one of the FEP or the PFA.

Meanwhile, in the photocatalyst layer of the fluororesin membrane material of the present application, the photocatalyst ratio, which is the ratio of the weight of the photocatalyst to the total weight of the photocatalyst and the fluororesins (i.e., PTFE+specific fluororesin), is set to 40% or less. As described above, in the fluororesin membrane material of the present application, the occurrence of a crack in the photocatalyst layer is prevented by: selecting the blend of the PTFE and the specific fluororesin as fluororesins forming the photocatalyst layer; and making the weight of the PTFE equal to or more than the weight of the specific fluororesin. However, an investigation by the inventor of the present application has found that, even in the case where the fluororesins in the photocatalyst layer satisfy the above-mentioned condition, when the weight ratio of the photocatalyst in the photocatalyst layer to the fluororesins becomes equal to or more than a certain value, a crack may occur in the photocatalyst layer, and it becomes difficult to thermally weld the fluororesin membrane materials. According to an investigation by the inventor of the present application, when the photocatalyst ratio in the photocatalyst layer is set to 40% or less, no crack is present, or even if a crack is present, the crack occurring in the photocatalyst layer of the fluororesin membrane material of the present application is brought into a state of being significantly suppressed as compared to at least the crack occurring in the photocatalyst layer of the related-art fluororesin membrane material, and moreover, at least in the case of a single-sided coated product, the thermal welding of the fluororesin membrane materials can be performed. The term “single-sided coated product” as used herein means a fluororesin membrane material including the photocatalyst layer in the present embodiments only on one surface thereof. In this case, a layer formed of at least one of the FEP or the PFA, the layer being free of any photocatalyst, is arranged on the other surface of the single-sided coated product. In such single-sided coated product, when the thermal welding of the fluororesin membrane materials is performed, for example, the edge portions of the fluororesin membrane materials are thermally welded under a state in which the photocatalyst layer and the layer formed of at least one of the FEP or the PFA, the layer being free of any photocatalyst, are in contact with each other. The above-mentioned phrase “in the case of a single-sided coated product, the thermal welding of the fluororesin membrane materials can be performed” means that such thermal welding can be performed.

In addition, the inventor of the present application has found that the incorporation of the PTFE into the photocatalyst layer exhibits an additional effect. When the PTFE is incorporated into the photocatalyst layer, voids that are fine pores the PTFE originally have as its characteristics are formed in the photocatalyst layer. The pores are much smaller than the above-mentioned crack, and hence there is substantially no possibility that biological dirt proliferates. However, the pores contribute to an increase in surface area of the photocatalyst. As a result, according to the fluororesin membrane material of the present embodiments, in the case where the weight of the photocatalyst in the photocatalyst layer is constant, its photocatalytic function is exhibited more satisfactorily than in the case where the fluororesin in the photocatalyst layer is the specific fluororesin alone. The photocatalytic function in this case is, for example, a self-cleaning function or an air purification function based on NOₓ decomposition.

The photocatalyst in the present application is powder. In addition, the photocatalyst is, for example, but not limited to, TiO₂.

As described above, in the photocatalyst layer of the fluororesin membrane material of the present application, the photocatalyst ratio, which is the ratio of the weight of the photocatalyst to the total weight of the photocatalyst and the fluororesins in the photocatalyst layer, is set to 40% or less. In other words, the photocatalyst ratio is appropriately determined in the range of 40% or less.

For example, the photocatalyst ratio may be set to 25% or less. With such procedure, when the specific fluororesin ratio is 50% or less, no crack is present, or even if a crack is present, the crack occurring in the photocatalyst layer of the fluororesin membrane material of the present application is brought into a state of being significantly suppressed as compared to at least the crack occurring in the photocatalyst layer of the related-art fluororesin membrane material. Particularly when the specific fluororesin ratio is 30% or less, especially 20% or less, a state in which no crack is present in the photocatalyst layer is established. In addition, when the photocatalyst ratio is set to 25% or less, the photocatalyst layers of fluororesin membrane materials each including the photocatalyst layers of the present application on both surfaces thereof (the membrane materials are each a fluororesin membrane material that should be referred to as “double-sided coated product” in imitation of the above-mentioned naming method) can be thermally welded with reliability. According to an investigation by the inventor of the present application, the reliability of such thermal welding depends on the photocatalyst ratio rather than on the specific fluororesin ratio. In that sense, the setting of the photocatalyst ratio to 25% or less has meaning in terms of an improvement in reliability particularly when the fluororesin membrane materials that are double-sided coated products are thermally welded. As described in the foregoing, in the case of a single-sided coated product, the photocatalyst ratio only needs to be 40% or less.

The photocatalyst ratio may be 20% or less. When the amount of the photocatalyst in the photocatalyst layer is reduced to the level, the possibility that a crack occurs in the photocatalyst layer can be reduced. Moreover, even when the photocatalyst ratio is reduced to the level, the self-cleaning function and air purification function of the photocatalyst layer can each be allowed to satisfy performance equal to or more than the minimum requirement.

Meanwhile, the photocatalyst ratio may be set to 15% or more. When the photocatalyst ratio in the photocatalyst layer is reduced, the possibility that a crack occurs in the photocatalyst layer can be reduced. However, when the photocatalyst ratio is excessively reduced, the self-cleaning function and air purification function of the photocatalyst layer of course become lower than the minimum necessary functions. Of those, in particular, the self-cleaning function useful in maintaining the beauty of the photocatalyst layer of the fluororesin membrane material during its use is satisfactorily maintained when the photocatalyst ratio is 15% or more.

As described above, in the photocatalyst layer of the fluororesin membrane material of the present application, the specific fluororesin ratio, which is the ratio of the weight of the specific fluororesin to the total weight of the specific fluororesin and the PTFE in the photocatalyst layer, is set to 50% or less irrespective of the photocatalyst ratio. In other words, the specific fluororesin ratio may be appropriately determined in the range of 50% or less irrespective of the photocatalyst ratio.

For example, the specific fluororesin ratio may be set to 30% or less. When the specific fluororesin ratio is reduced to the magnitude or less, particularly in the case where the photocatalyst ratio is set to about 15%, no crack occurs in the photocatalyst layer, and the self-cleaning ability of the photocatalyst layer becomes sufficient.

The specific fluororesin ratio may be set to 25% or less. In the case where the specific fluororesin ratio is reduced to the level, even when the photocatalyst ratio is increased to about 25%, a crack in the photocatalyst layer is significantly alleviated as compared to at least a related-art product, and the self-cleaning ability of the photocatalyst layer becomes sufficient.

The specific fluororesin ratio may be set to 20% or less. When the amount of the PTFE is increased to the level, the air purification performance of the photocatalyst layer is improved by the effects of the voids.

The specific fluororesin ratio may be set to 10% or more. With such procedure, the efficiency of the thermal welding is improved. As the specific fluororesin ratio is reduced, a crack is further prevented from occurring in the photocatalyst layer, and the number of the voids formed by the PTFE in the photocatalyst layer increases. Accordingly, the self-cleaning function and the air purification function are improved, and hence the required amount of the photocatalyst can be reduced. Instead, however, when the specific fluororesin ratio becomes excessively small, the thermal welding of the fluororesin membrane materials may require long time to result in poor efficiency. The specific fluororesin ratio is desirably set to 10% or more for improving the efficiency of the thermal welding of the fluororesin membrane materials.

The photocatalyst layer in the fluororesin membrane material of the present application may contain a carbonate irrespective of the photocatalyst ratio and the specific fluororesin ratio. Calcium carbonate, barium carbonate, magnesium carbonate, lithium carbonate, strontium carbonate, or the like may be utilized as the carbonate.

The inventor of the present application has found that the addition of the carbonate typified by calcium carbonate to the photocatalyst layer improves the self-cleaning function and air purification function of the photocatalyst layer. When the addition of the carbonate to the photocatalyst layer improves the two photocatalytic functions or makes the two photocatalytic functions comparable to conventional functions, the use of an inexpensive carbonate can reduce the usage amount of the photocatalyst that is more expensive than the carbonate.

The weight of the carbonate in the photocatalyst layer may be set to 20 wt % or less with respect to the weight of the photocatalyst in the photocatalyst layer. In addition, the weight of the carbonate is desirably set to about 10% (e.g., about 10%±2%) with respect to the weight of the photocatalyst. According to an investigation by the inventor of the present application, as the amount of the carbonate to be added to the photocatalyst layer is increased, the air purification function of the photocatalyst layer is improved, but when the weight of the carbonate exceeds 10% with respect to the weight of the photocatalyst, the function starts to reduce, and in the case where the weight of the carbonate becomes about 20% with respect to the weight of the photocatalyst, the function becomes substantially equal to that in the case where no carbonate is added to the photocatalyst layer. Therefore, the addition of the carbonate to the photocatalyst layer exhibits such effect as described above, but has no meaning particularly in terms of the air purification function when the weight of the carbonate exceeds 20% with respect to the weight of the photocatalyst.

In addition, the weight of the carbonate in the photocatalyst layer may be set to 10 wt % or less with respect to the weight of the photocatalyst in the photocatalyst layer. According to an investigation by the inventor of the present application, as the amount of the carbonate to be added to the photocatalyst layer is increased, the self-cleaning function of the photocatalyst layer is improved, but when the weight of the carbonate exceeds 10% with respect to the weight of the photocatalyst, the function remains substantially unchanged. Therefore, in the case where the weight of the carbonate becomes about 10% with respect to the weight of the photocatalyst, the function becomes substantially equal to that in the case where no carbonate is added to the photocatalyst layer. Therefore, the addition of the carbonate at a ratio of 10% or less to the photocatalyst layer can provide functions substantially close to upper limits in terms of both the air purification function and the self-cleaning function.

The weight of the carbonate in the photocatalyst layer may be set to 5 wt % or more with respect to the weight of the photocatalyst in the photocatalyst layer. The addition of the carbonate at a ratio of 5 wt % or more with respect to the weight of the photocatalyst improves each of the self-cleaning function and air purification function of the photocatalyst layer by about 50% as compared to that when the carbonate is absent.

When the photocatalyst layer contains the carbonate, the total weight of the photocatalyst and the carbonate in the photocatalyst layer may be set to 40% or less with respect to the total weight of the photocatalyst, the carbonate, and the fluororesins in the photocatalyst layer. When the total weight of the photocatalyst and the carbonate in the photocatalyst layer excessively increases, the long-term adhesive performance of the fluororesin membrane material may be poor, but when the total weight of the photocatalyst and the carbonate in the photocatalyst layer is set to about the above-mentioned weight, such inconvenience can be prevented. In particular, when the total weight of the photocatalyst and the carbonate in the photocatalyst layer is set to 40% or less with respect to the total weight of the photocatalyst, the carbonate, and the fluororesins in the photocatalyst layer, the long-term adhesive performance of the fluororesin membrane material serving as a single-sided coated product is easily satisfied, and when the total weight of the photocatalyst and the carbonate in the photocatalyst layer is set to 25% or less with respect to the total weight of the photocatalyst, the carbonate, and the fluororesins in the photocatalyst layer, the long-term adhesive performance of the fluororesin membrane material serving as a double-sided coated product is easily satisfied.

In the fluororesin membrane material of the present application, when the photocatalyst layer contains the carbonate, the photocatalyst layer may contain an inorganic pigment for coloring the photocatalyst layer. An investigation by the inventor of the present application has found that, in the case where the carbonate is added to the photocatalyst layer having added thereto the inorganic pigment, the color development of the photocatalyst layer is improved as compared to that in the case where no carbonate is added. There has heretofore been a problem in that, even when an attempt is made to color the photocatalyst layer, its color development is not improved. However, the problem is solved by adding the carbonate to the photocatalyst layer in addition to the inorganic pigment.

The weight of the inorganic pigment in the photocatalyst layer may be set to 3 wt % or less with respect to the weight of the photocatalyst layer. When the photocatalyst layer contains the carbonate and the inorganic pigment, the total weight of the photocatalyst, the carbonate, and the inorganic pigment in the photocatalyst layer may be set to 40% or less with respect to the total weight of the photocatalyst, the carbonate, the inorganic pigment, and the fluororesins in the photocatalyst layer. When the total weight of the photocatalyst, the carbonate, and the inorganic pigment in the photocatalyst layer excessively increases, the long-term adhesive performance of the fluororesin membrane material may be poor, but when the total weight of the photocatalyst, the carbonate, and the inorganic pigment in the photocatalyst layer is set to about the above-mentioned weight, such inconvenience can be prevented. In particular, when the total weight of the photocatalyst, the carbonate, and the inorganic pigment in the photocatalyst layer is set to 40% or less with respect to the total weight of the photocatalyst, the carbonate, the inorganic pigment, and the fluororesins in the photocatalyst layer, the long-term adhesive performance of the fluororesin membrane material serving as a single-sided coated product is easily satisfied, and when the total weight of the photocatalyst, the carbonate, and the inorganic pigment in the photocatalyst layer is set to 25% or less with respect to the total weight of the photocatalyst, the carbonate, the inorganic pigment, and the fluororesins in the photocatalyst layer, the long-term adhesive performance of the fluororesin membrane material serving as a double-sided coated product is easily satisfied.

The inventor of the present application also proposes, as one embodiment, a method of producing a fluororesin membrane material, which exhibits the same effects as those of the fluororesin membrane material according to the embodiment of the present document.

An example of the method of producing a fluororesin membrane material is a method of producing a fluororesin membrane material for obtaining a fluororesin membrane material by forming a photocatalyst layer containing a photocatalyst and fluororesins on at least one outermost surface of a fluororesin layer containing a PTFE as a fluororesin, the method including: applying a dispersion containing the photocatalyst and the fluororesins to at least one surface of the fluororesin layer; drying the dispersion; calcining the fluororesin layer having applied thereto the dispersion at a temperature equal to or more than a melting point of any fluororesin of the fluororesins incorporated into the dispersion; and cooling the calcined fluororesin layer having applied thereto the dispersion to room temperature, wherein the photocatalyst and the fluororesins in the dispersion to be applied to the fluororesin layer satisfy a photocatalyst ratio, which is a ratio of a weight of the photocatalyst to a total weight of the photocatalyst and the fluororesins, of 40% or less, and wherein the fluororesins in the dispersion to be applied to the fluororesin layer are formed of a specific fluororesin that is a fluorinated resin copolymer having a melting point of 240° C. or more and a continuous use temperature of 200° C. or more, and the PTFE, and the specific fluororesin and the PTFE in the dispersion satisfy a specific fluororesin ratio, which is a ratio of a weight of the specific fluororesin to a total weight of the specific fluororesin and the PTFE, of 50% or less.

The above-mentioned cooling may be natural cooling or forced cooling, and a cooling time is not particularly limited. The inventor of the present application has confirmed that the state of a crack occurring in the photocatalyst layer is substantially unchanged by a difference in cooling condition.

### BRIEF DESCRIPTION OF DRAWINGS

FIG. 1 are enlarged photographs of the surfaces of the photocatalyst layers of test membrane materials obtained in Test Example 1, in which FIG. 1(A) is a photograph for showing VTi15FEP100, FIG. 1(B) is a photograph for showing VTi15FEP75, FIG. 1(C) is a photograph for showing VTi15FEP50, and FIG. 1(D) is a photograph for showing VTi15FEP40;

FIG. 2 are enlarged photographs of the surfaces of the photocatalyst layers of the test membrane materials obtained in Test Example 1, in which FIG. 2(E) is a photograph for showing VTi15FEP35, FIG. 2(F) is a photograph for showing VTi15FEP30, FIG. 2(G) is a photograph for showing VTi15FEP25, and FIG. 2(H) is a photograph for showing VTi15FEP0;

FIG. 3 are enlarged photographs of the surfaces of the photocatalyst layers of test membrane materials obtained in Test Example 2, in which FIG. 3(A) is a photograph for showing VTi15FEP25, FIG. 3(B) is a photograph for showing VTi20FEP25, and FIG. 3(C) is a photograph for showing VTi25FEP25;

FIG. 4 are enlarged photographs of the surfaces of the photocatalyst layers of the test membrane materials obtained in Test Example 2, in which FIG. 4(A) is a photograph for showing LTi15FEP25, FIG. 4(B) is a photograph for showing LTi20FEP25, and FIG. 4(C) is a photograph for showing LTi25FEP25;

FIG. 5 are enlarged photographs of the surfaces of the photocatalyst layers of test membrane materials obtained in Test Example 3, in which FIG. 5(A) is a photograph for showing LTi20FEP100, FIG. 5(B) is a photograph for showing LTi25FEP100, FIG. 5(C) is a photograph for showing LTi30FEP100, and FIG. 5(D) is a photograph for showing LTi35FEP100; and

FIG. 6 are enlarged photographs of the surfaces of the photocatalyst layers of the test membrane materials obtained in Test Example 3, in which FIG. 6(E) is a photograph for showing LTi40FEP100 and FIG. 6(F) is a photograph for showing LTi45FEP100.

### DESCRIPTION OF EMBODIMENTS

Embodiments are described below with reference to the drawings.

A fluororesin membrane material according to this embodiment includes: a fluororesin layer containing a PTFE as a fluororesin; and a photocatalyst layer arranged on at least one outermost surface of the fluororesin layer, the photocatalyst layer containing a photocatalyst and fluororesins.

All constructions of portions excluding the photocatalyst layer in the construction of such fluororesin membrane material may be existing, and moreover, commercially available constructions. For example, Chukoh Chemical Industries, Ltd. manufactures and sells a “fluororesin membrane material” named FGT Series (trademark). Such fluororesin membrane material is produced by repeating the following treatment: a glass fiber B yarn cloth is impregnated with a dispersion of the PTFE, and the dispersion is dried by, for example, heating, followed by the calcination of the resultant. As a result, the fluororesin membrane material is of a structure in which both surfaces of the cloth formed of the glass fibers are coated with the PTFE. It is because of the following reason that both the processes, that is, the impregnation of the cloth formed of the glass fibers with the dispersion, and the heating and the calcination are repeated: the thickness of a PTFE layer that can be formed on the surface of the cloth formed of the glass fibers by performing the above-mentioned processes once is not so large, and hence the thickness of the PTFE layer needs to be made sufficient by repeating both the above-mentioned processes.

Such method of producing a fluororesin membrane material is known or well known. Such known or well-known method as described above may be diverted as it is to a process excluding a process for the production of a photocatalyst layer in a method of producing a fluororesin membrane material according to this embodiment to be described below.

In this embodiment, the photocatalyst and the fluororesins in the above-mentioned photocatalyst layer after the completion satisfy a photocatalyst ratio, which is the ratio of the weight of the photocatalyst to the total weight of the photocatalyst and the fluororesins, of 40% or less. In addition, the fluororesins in the above-mentioned photocatalyst layer are formed of a specific fluororesin that is a fluorinated resin copolymer having a melting point of 240° C. or more and a continuous use temperature of 200° C. or more, and the PTFE, and the specific fluororesin and the PTFE in the photocatalyst layer satisfy a specific fluororesin ratio, which is the ratio of the weight of the specific fluororesin to the total weight of the specific fluororesin and the PTFE, of 50% or less. The photocatalyst may be the same as a photocatalyst that has been used in a conventional photocatalyst layer. The photocatalyst is powdery, and is typically TiO₂. The specific fluororesin may be, for example, at least one of a FEP or a PFA.

More specifically, the photocatalyst ratio in the photocatalyst layer may be set to 25% or less, and moreover, may be set to 20% or less. In addition, the photocatalyst ratio in the photocatalyst layer may be set to, but not limited to, 15% or more.

In addition, more specifically, the specific fluororesin ratio in the photocatalyst layer may be set to 30% or less, moreover, may be set to 25% or less, and moreover, may be set to 20% or less. In addition, the specific fluororesin ratio in the photocatalyst layer may be set to, but not limited to, 10% or more.

In addition, the above-mentioned photocatalyst layer may contain a carbonate. The carbonate is, for example, calcium carbonate, but in addition thereto, barium carbonate, magnesium carbonate, lithium carbonate, strontium carbonate, or the like may be used. The weight of the carbonate in the photocatalyst layer may be set to, for example, but not limited to, 20 wt % or less with respect to the weight of the photocatalyst in the photocatalyst layer, and moreover, may be set to 10 wt % or less with respect to the weight of the photocatalyst in the photocatalyst layer. In addition, the weight of the carbonate in the photocatalyst layer is set to, but not limited to, 5 wt % or more with respect to the weight of the photocatalyst in the photocatalyst layer. The weight of the carbonate in the photocatalyst layer is desirably set to about 10% (e.g., about 10%±2%) with respect to the weight of the photocatalyst in the photocatalyst layer.

In addition, when the photocatalyst layer contains the carbonate, the photocatalyst layer may contain an inorganic pigment for coloring the photocatalyst layer. When the photocatalyst layer contains the inorganic pigment, the weight of the inorganic pigment may be set to 3 wt % or less with respect to the weight of the photocatalyst layer (the total weight of the photocatalyst, the fluororesins (PTFE+specific fluororesin), the carbonate, and the inorganic pigment).

When the photocatalyst layer contains the carbonate, the total weight of the photocatalyst and the carbonate in the photocatalyst layer may be set to 40% or less with respect to the total weight of the photocatalyst, the carbonate, and the fluororesins in the photocatalyst layer. When the total weight of the photocatalyst and the carbonate in the photocatalyst layer is set to 40% or less with respect to the total weight of the photocatalyst, the carbonate, and the fluororesins in the photocatalyst layer, the long-term adhesive performance of the fluororesin membrane material serving as a single-sided coated product is easily satisfied, and when the total weight of the photocatalyst and the carbonate in the photocatalyst layer is set to 25% or less with respect to the total weight of the photocatalyst, the carbonate, and the fluororesins in the photocatalyst layer, the long-term adhesive performance of the fluororesin membrane material serving as a double-sided coated product is easily satisfied.

When the photocatalyst layer contains the carbonate and the inorganic pigment, the total weight of the photocatalyst, the carbonate, and the inorganic pigment in the photocatalyst layer may be set to 40% or less with respect to the total weight of the photocatalyst, the carbonate, the inorganic pigment, and the fluororesins in the photocatalyst layer, that is, the weight of the photocatalyst layer. When the total weight of the photocatalyst, the carbonate, and the inorganic pigment in the photocatalyst layer is set to 40% or less with respect to the total weight of the photocatalyst, the carbonate, the inorganic pigment, and the fluororesins in the photocatalyst layer, the long-term adhesive performance of the fluororesin membrane material serving as a single-sided coated product is easily satisfied, and when the total weight of the photocatalyst, the carbonate, and the inorganic pigment in the photocatalyst layer is set to 25% or less with respect to the total weight of the photocatalyst, the carbonate, the inorganic pigment, and the fluororesins in the photocatalyst layer, the long-term adhesive performance of the fluororesin membrane material serving as a double-sided coated product is easily satisfied.

A method of producing such fluororesin membrane material as described above is as described below.

First, an appropriate fluororesin membrane material like FGT Series manufactured by Chukoh Chemical Industries, Ltd. (the membrane material is different from a fluororesin membrane material serving as the final product, and should be considered to be a semi-product in this embodiment irrespective of whether or not the membrane material is sold as the final product) is prepared. Such preparation may be performed by purchasing a product manufactured and sold by a third party, or may be performed by single-handedly producing the membrane material according to the above-mentioned known or well-known method.

Next, the photocatalyst layer is formed on at least one surface of the PTFE layer of the fluororesin membrane material one example of which is the FGT Series. Although the photocatalyst layer is not necessarily required to cover the entire surface of the fluororesin layer on which the layer is formed, the layer covers the entire surface in this embodiment.

The photocatalyst layer is formed on the outermost surface of the PTFE layer as described below. First, a dispersion containing the PTFE and the FEP serving as fluororesins to be finally incorporated into the photocatalyst layer, and the photocatalyst to be finally incorporated into the photocatalyst layer is prepared. Such dispersion may basically be the same as a dispersion that has been used for forming a conventional photocatalyst layer except that the dispersion contains the PTFE.

When the dispersion is the simplest dispersion, the dispersion contains the photocatalyst, the specific fluororesin (e.g., the FEP (or the PFA, or the FEP and the PFA), the same holds true for the following), and the PTFE. The dispersion may of course contain a known or well-known defoaming agent, surfactant, or the like, and for example, water may be selected as a liquid for dispersing the photocatalyst, the specific fluororesin, the PTFE, and the like. When such dispersion is used, the photocatalyst layer to be obtained later contains the photocatalyst, the specific fluororesin, and the PTFE.

As described above, the photocatalyst layer contains calcium carbonate in some cases (Although any one of the above-mentioned candidate substances of the carbonate is permitted, calcium carbonate is used as the carbonate for simplicity. The same holds true for the following). In such cases, calcium carbonate that is powder only needs to be added to the above-mentioned simplest dispersion, or a calcium carbonate-containing titanium oxide dispersion may be prepared in advance at the time of the preparation and production of the dispersion.

In addition, as described above, the photocatalyst layer in the case where calcium carbonate is added thereto may contain the inorganic pigment. The inorganic pigment that is powder only needs to be further added to the above-mentioned dispersion containing calcium carbonate for obtaining such photocatalyst layer. However, which one of calcium carbonate and the inorganic pigment is added earlier in the case of the production of the dispersion is not limited.

No matter what kind of dispersion is used, when the photocatalyst layer is formed, the dispersion is applied in a predetermined thickness onto the PTFE layer of the fluororesin membrane material one example of which is the FGT Series. Such application may be achieved by an appropriate approach, such as the use of a bar coater or the immersion of the fluororesin membrane material in the dispersion. Next, the fluororesin membrane material as a semi-finished product in which the dispersion is applied to the surface of the PTFE layer is heated and dried, and is then calcined. Although a temperature at the time of the calcination is preferably a temperature equal to or more than the melting point (about 327° C.) of the fluororesin having the highest melting point (i.e., the PTFE) out of the fluororesins in the dispersion, the calcination may be performed at a temperature equal to or less than the melting point of the fluororesin having the highest melting point depending on a blending ratio between the respective fluororesins, and the calcination only needs to be performed at a temperature higher than at least the melting point of any one of the fluororesins in the dispersion for forming the photocatalyst layer. Thus, water in the dispersion is evaporated at the time of the heating and drying, and moreover, both the PTFE and the specific fluororesin in the dispersion are melted at the time of the calcination.

After that, the resultant is cooled to room temperature to solidify the PTFE and the specific fluororesin, and to cause the fluororesins to carry the photocatalyst. Thus, the fluororesin membrane material in this embodiment is completed. When the thickness of the photocatalyst layer is insufficient, the foregoing treatment in which the dispersion is applied, heated and dried, calcined, and cooled only needs to be repeated until the thickness of the photocatalyst layer becomes appropriate.

The weights of solid components in the dispersion (the photocatalyst, the PTFE, the specific fluororesin, calcium carbonate, and the inorganic pigment) do not change even after the following respective processes: the dispersion is applied to the outermost surface layer of the PTFE layer, heated and dried, calcined, and then cooled. In other words, the weights and weight ratios of the respective solid components in the dispersion are as follows: the weights and weight ratios in the dispersion, and those in the photocatalyst layer are the same. Therefore, when the weight ratios of the solid components in the dispersion (the photocatalyst, the PTFE, the specific fluororesin, calcium carbonate, and the inorganic pigment), such as the photocatalyst ratio and a FEP ratio, are adjusted in advance to the above-mentioned ratios, the ratios of the solid components in the photocatalyst layer in the fluororesin membrane material produced by using the dispersion can be set as described above.

Test Examples are described below. In each of the following test examples, FGT-800 (trademark, hereinafter referred to as “semi-product membrane”) out of the FGT Series manufactured by Chukoh Chemical Industries, Ltd. is used as the above-mentioned fluororesin membrane material serving as a semi-product, and a photocatalyst layer is formed on the outermost surface of one of both surfaces thereof each of which is formed of a PTFE (provided that the outermost surface is formed of a FEP).

### Test Example 1

In Test Example 1, a dispersion was produced as described below.

The dispersion was formed of a titanium oxide slurry V (a slurry containing titanium oxide (manufactured by Ishihara Sangyo Co., Ltd., product number: ST-01), water, a dispersant, and any other additive, and having a titanium oxide concentration adjusted to 15% is referred to as “titanium oxide slurry V” for convenience) serving as a titanium oxide slurry, water, a FEP dispersion (manufactured by E.I. du Pont de Nemours and Company, solid content concentration: 55%, product number: FEP-D121), a PTFE dispersion (manufactured by Mitsui Du Pont Fluorochemical Co., Ltd., solid content concentration: 60%, product number: PTFE-31JR), a silicone-based defoaming agent, and a surfactant (manufactured by DIC Corporation, product number: F444), and was produced by mixing appropriate amounts of the components and stirring the mixture.

In Test Example 1, 8 kinds of dispersions were produced. In all the dispersions, ratios between titanium oxide (TiO₂) and the fluororesins in photocatalyst layers to be finally obtained were allowed to have a constant value of 15:85 (i.e., photocatalyst ratios were allowed to have a constant value of 15%). In addition, ratios between the FEP and the PTFE in the fluororesins in the respective dispersions were changed. Specifically, ratios between the FEP and the PTFE in the photocatalyst layers to be finally obtained when the respective dispersions were used were allowed to change between 100:0 and 0:100 (i.e., specific fluororesin ratios (a specific fluororesin ratio in the case where a specific fluororesin is the FEP alone out of the specific fluororesin ratios is hereinafter simply referred to as “FEP ratio”) were allowed to change in the range of from 100% to 0%). The total solid content concentration of titanium oxide and the fluororesins in each of the dispersions was adjusted to 28%.

Each of the dispersions (and the photocatalyst layer produced by using the dispersion) is represented like, for example, “VTi15FEP100”, and the same holds true for the following. In this case, the head symbol “V” means that the dispersion (or a fluororesin membrane material including the photocatalyst layer produced by using the dispersion, the same holds true for the following) is free of calcium carbonate. As described later, when a dispersion contains calcium carbonate, the head symbol is “L”. Next, the number “15” behind Ti represents a photocatalyst ratio (%). In addition, the number “100” behind FEP represents a FEP ratio (%). In other words, the symbol “VTi15FEP100” represents the following contents: a dispersion that is free of calcium carbonate, and has a photocatalyst ratio of 15% and a FEP ratio of 100%.

The 8 kinds of dispersions produced in Test Example 1 are described by the foregoing representation method as follows: VTi15FEP100, VTi15FEP75, VTi15FEP50, VTi15FEP40, VTi15FEP35, VTi15FEP30, VTi15FEP25, and VTi15FEP0.

Next, one surface of the semi-product membrane was coated with one of the 8 kinds of dispersions by using a glass rod. The glass rod has a diameter of 10 mm and a length of 240 mm. Next, the semi-product membrane having one surface coated with the dispersion was dried in a drying furnace having an atmosphere at 60° C. for 3 minutes so that water was evaporated. Thus, a coating membrane was formed. After that, the resultant was calcined at an appropriate temperature in the range of from 300° C. to 330° C. (A temperature during the calcination may be constant or may fluctuate in the range. When the temperature during the calcination falls within the range, the temperature is a temperature equal to or more than the melting point of the FEP.) for 5 minutes, and was then air-cooled under a room temperature atmosphere. Thus, a fluororesin membrane material was produced.

Eight kinds of test membrane materials (fluororesin membrane materials) were obtained by performing the foregoing treatment through the use of the 8 kinds of dispersions. Next, tests were performed on each of the 8 test membrane materials. The tests are a test for the presence or absence of a crack, and a test for the self-cleaning function of a photocatalyst layer.

[Presence or Absence of Crack]

The test for the presence or absence of a crack was performed by observing the surface of a photocatalyst layer with a scanning electron microscope (SEM). The used microscope is an electron microscope manufactured by JEOL Ltd. (product number: JSM-6510LA), and a magnification at the time of the observation is 200.

The results of the test were as shown in Table 1 below, and a test membrane material in which no continuous crack was observed in the surface was indicated by Symbol “o”, a test membrane material in which an elongated crack was present but no tortoise shell-like crack occurred was indicated by Symbol “Δ”, and a test membrane material in which a tortoise shell-like crack similar to that of a current product occurred was indicated by Symbol “x”.

TABLE 1

| VTi15 | VTi15 | VTi15 | VTi15 | VTi15 | VTi15 | VTi15 | VTi15 |
|---|---|---|---|---|---|---|---|
| FEP100 | FEP75 | FEP50 | FEP40 | FEP35 | FEP30 | FEP25 | FEP0 |
| × | × | Δ | Δ | Δ | ○ | ○ | ○ |

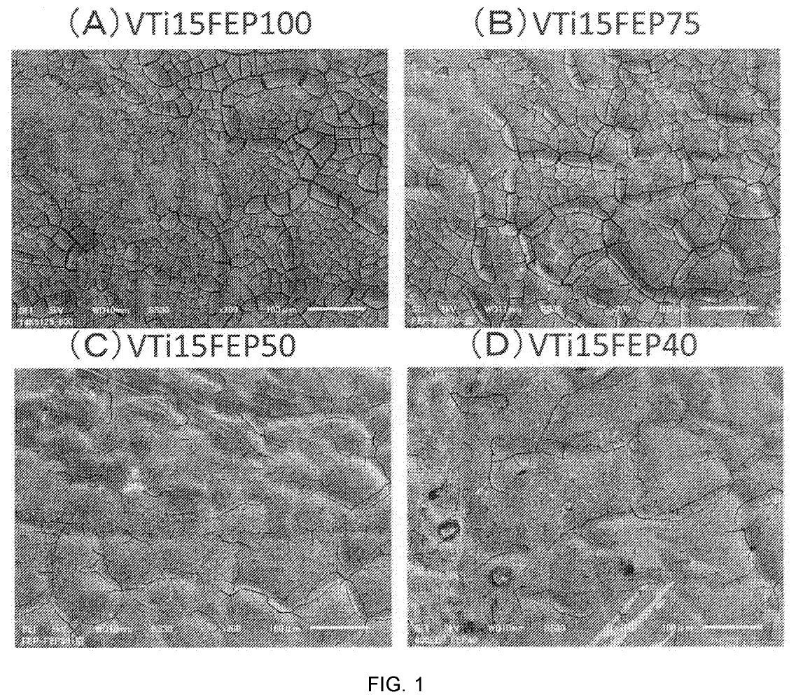

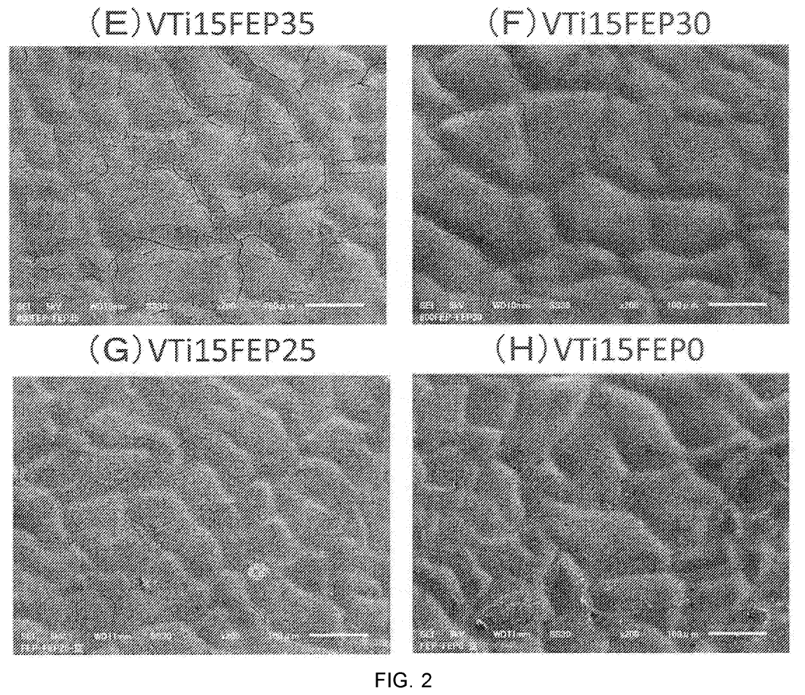

Of those, the VTi15FEP100 virtually corresponds to the current product because the fluororesin forming the photocatalyst layer is the FEP alone. It is found that a tortoise shell-like crack occurs in the test membrane material (FIG. 1(A)). Meanwhile, a tortoise shell-like crack still remains in the VTi15FEP75 (FIG. 1(B)), but as the FEP ratio reduces, the VTi15FEP50 is the first to be brought into a state in which an elongated crack is present but no tortoise shell-like crack occurs (FIG. 1(C)), and the VTi15FEP40 and the VTi15FEP35 are also brought into similar states (FIG. 1(D) and FIG. 2(E)). As the FEP ratio further reduced, the VTi15FEP30 was the first to be brought into a state in which no continuous crack was observed in the surface (FIG. 2(F)), and the state was similarly observed in the VTi15FEP25 and the VTi15FEP0 (FIG. 2(G) and FIG. 2(H)).

It is found from the foregoing that, when the photocatalyst ratio is constant, a crack is further prevented from occurring as the FEP ratio reduces.

[Self-cleaning Function]

An evaluation for a self-cleaning function was performed by determining a decomposition activity index according to the “Fine ceramics-Test method for self-cleaning performance of photocatalytic materials-Part 2: Wet decomposition performance” of JIS R 1703-2. A test membrane material in which the determined decomposition activity index was 20 nmol/L/min or more was indicated by Symbol “o”, a test membrane material in which the determined decomposition activity index was from 15 nmol/L/min to 20 nmol/L/min was indicated by Symbol “Δ”, and a test membrane material in which the determined decomposition activity index was 15 nmol/L/min or less was indicated by Symbol “x”.

The results of the evaluation are shown in Table 2.

TABLE 2

| VTi15 | VTi15 | VTi15 | VTi15 | VTi15 | VTi15 | VTi15 | VTi15 |
|---|---|---|---|---|---|---|---|
| FEP100 | FEP75 | FEP50 | FEP40 | FEP35 | FEP30 | FEP25 | FEP0 |
| 18.1 | 18.5 | 18.4 | 24.3 | 27.6 | 25.2 | 27.6 | 27.4 |
| Δ | Δ | Δ | ○ | ○ | ○ | ○ | ○ |

Unit: nmol/L/min

With regard to the self-cleaning function, as compared to the VTi15FEP100 corresponding to the virtual current product in which the photocatalyst layer does not contain the PTFE, the self-cleaning functions of all other test membrane materials in each of which the photocatalyst layer contains the PTFE are improved. When the photocatalyst ratio is constant, the following tendency is observed: as the FEP ratio reduces, the self-cleaning function enlarges. Particularly when the FEP ratio becomes 40% or less, a significant improvement in self-cleaning function is observed.

### Test Example 2

In Test Example 2, first, a plurality of kinds of dispersions was produced in the same manner as in Test Example 1. The produced dispersions were 3 kinds each of which was free of calcium carbonate, and 3 kinds each containing calcium carbonate.

Materials used in the production of the dispersions each of which is free of calcium carbonate are the same as those of Test Example 1. In addition, the total solid content concentration of titanium oxide and the fluororesins in each of the dispersions was adjusted to 28%.

The 3 kinds of dispersions produced in Test Example 2 each of which is free of calcium carbonate are as follows: VTi15FEP25, VTi20FEP25, and VTi25FEP25.

Meanwhile, materials used in the production of the dispersions each containing calcium carbonate were also basically the same as those of Test Example 1, but when the dispersions each containing calcium carbonate were produced, a titanium oxide slurry L (a slurry containing titanium oxide (manufactured by Ishihara Sangyo Co., Ltd., product number: ST-01), calcium carbonate (manufactured by Shiraishi Calcium Kaisha, Ltd., product number: SOFTON 1200), water, a dispersant, and any other additive, and having a titanium oxide concentration and a calcium carbonate concentration adjusted to 28% and 2.8%, respectively is referred to as “titanium oxide slurry L” for convenience) was used instead of the titanium oxide slurry V of Test Example 1. The titanium oxide slurry L contains calcium carbonate in a weight corresponding to 10% of the weight of titanium oxide. In addition, the total solid content concentration of titanium oxide and the fluororesins in each of the dispersions was adjusted to 28%.

The 3 kinds of dispersions produced in Test Example 2 each containing calcium carbonate are as follows: LTi15FEP25, LTi20FEP25, and LTi25FEP25.

Six kinds of test membrane materials were produced by using the 6 kinds of dispersions under the same conditions as those of Test Example 1.

A test for the presence or absence of a crack, and a test for the self-cleaning function of a photocatalyst layer were performed on each of the 6 kinds of test membrane materials under the same conditions as those of Test Example 1. In addition, a test for a NOₓ-decomposing function to be described later was performed on each of the 6 kinds of test membrane materials.

[Presence or Absence of Crack]

The results of the test are shown in Table 3 below.

TABLE 3

| | |
|---|---|
| VTi15FEP25 | ∘ |
| VTi20FEP25 | ∘ |
| VTi25FEP25 | Δ |
| LTi15FEP25 | ∘ |
| LTi20FEP25 | ∘ |
| LTi25FEP25 | Δ |

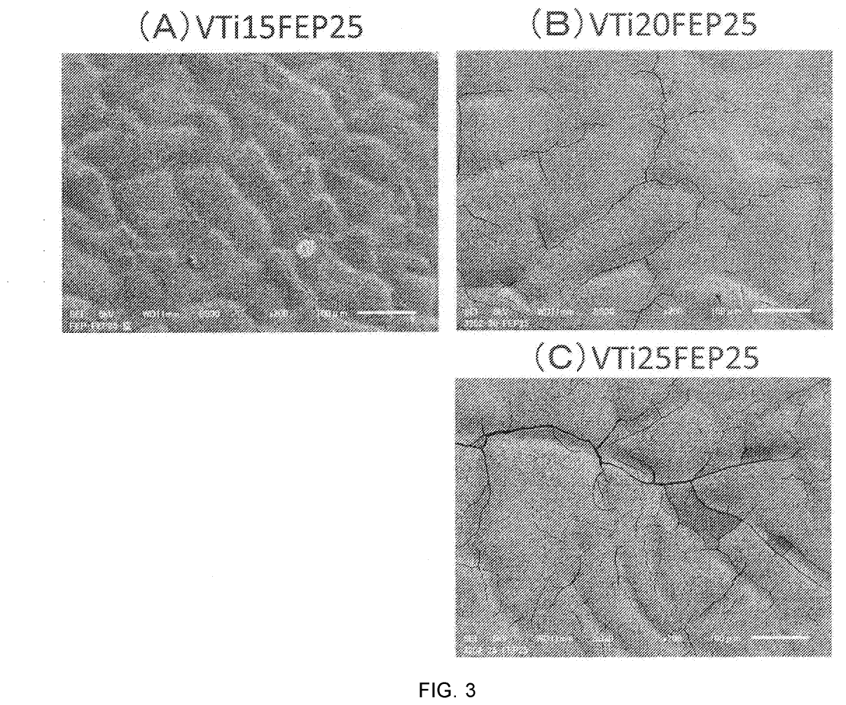

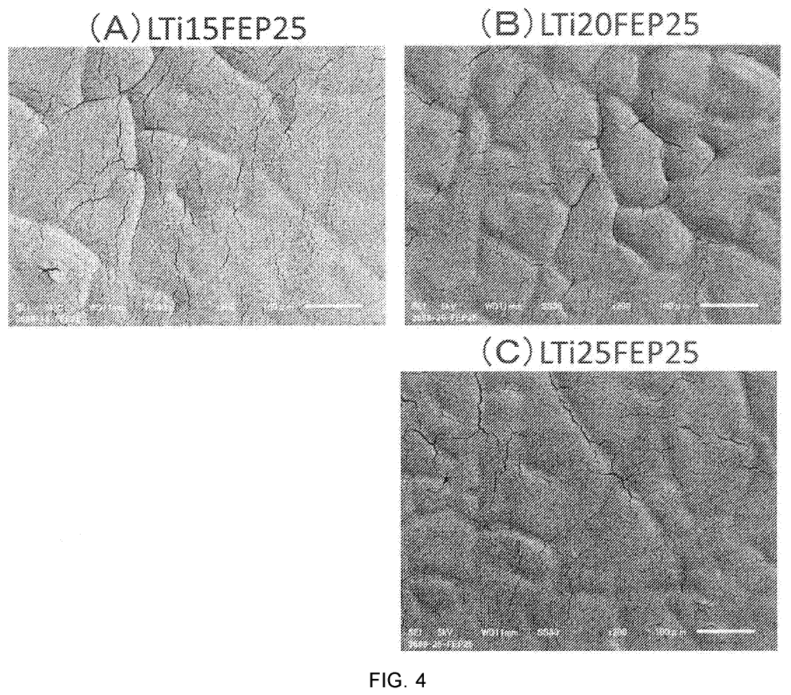

The results of the test in the cases where calcium carbonate was present and those in the cases where calcium carbonate was absent were the same. In each of the cases, when the FEP ratio is constant, as the photocatalyst ratio reduces, a crack more hardly occurs. Although the results of the test were the same as described above, a crack tended to be suppressed in a photocatalyst layer containing calcium carbonate as compared to a photocatalyst layer free of calcium carbonate (the VTi15FEP25 shown in FIG. 3(A), the VTi20FEP25 shown in FIG. 3(B), the VTi25FEP25 shown in FIG. 3(C), the LTi15FEP25 shown in FIG. 4(A), the LTi20FEP25 shown in FIG. 4(B), and the LTi25FEP25 shown in FIG. 4(C)). This is probably because, in the case where calcium carbonate is present in a dispersion, when fluororesins in the dispersion melted once by the calcination of the dispersion after its heating and drying are cooled to be solidified, their fluidity is suppressed.

[Self-cleaning Function]

An evaluation for a self-cleaning function was performed in the same manner as in Test Example 1.

The results of the evaluation are shown in Table 4.

TABLE 4
Unit: nmol/L/min

| | |
|---|---|
| VTi15FEP25 | ∘ (27.6) |
| VTi20FEP25 | ∘ (22.6) |
| VTi25FEP25 | ∘ (25.4) |
| LTi15FEP25 | Δ (19.0) |
| LTi20FEP25 | ∘ (21.9) |
| LTi25FEP25 | ∘ (23.4) |

As shown in Table 4, in each of the cases where calcium carbonate was present and the cases where calcium carbonate was absent, when the FEP ratio was constant, as the photocatalyst ratio increased, an improvement in self-cleaning function was observed. In addition, the following tendency was observed: the self-cleaning function of a photocatalyst layer containing calcium carbonate was somewhat inferior to that of a photocatalyst layer free of calcium carbonate, though the degree of inferiority did not cause a problem.

[NOₓ-decomposing Function]

The air purification performance of a photocatalytic material was evaluated by a test for a NOₓ-decomposing function. In the evaluation for a NOₓ-decomposing function, a NOₓ removal amount per one test piece was measured by the “test method for a test piece having a small removal amount (so-called relaxed condition)” of “Fine ceramics-Test method for air purification performance of photocatalytic materials-Part 1: Removal of nitric oxide” of JIS R 1701-1.

In the evaluation for a NOₓ-decomposing function, a test membrane material in which the NOₓ removal amount was not less than 0.5 μmol corresponding to the product certification standard value of the Photocatalysis Industry Association of Japan (PIAJ) concerning air purification performance (NOₓ) was indicated by Symbol “o”, a test membrane material in which the NOₓ removal amount was from 0.25 μmol to 0.5 μmol corresponding to the range of from a measurable lower limit value to the certification standard value was indicated by Symbol “Δ”, and a test membrane material in which the NOₓ removal amount was not more than 0.25 μmol corresponding to the measurable lower limit value was indicated by Symbol “x”.

The results of the evaluation are shown in Table 5.

TABLE 5
Unit: μmol

| VTi15FEP25 | x (0.07) |
|---|---|
| VTi20FEP25 | x (0.12) |
| VTi25FEP25 | Δ (0.34) |
| LTi15FEP25 | Δ (0.34) |
| LTi20FEP25 | ∘ (0.50) |
| LTi25FEP25 | ∘ (0.68) |

As shown in Table 5, in each of the cases where calcium carbonate was present and the cases where calcium carbonate was absent, when the FEP ratio was constant, as the photocatalyst ratio increased, an improvement in NOₓ-decomposing function was observed. In addition, it was found that the NOₓ-decomposing function of a photocatalyst layer containing calcium carbonate was remarkably increased as compared to that of a photocatalyst layer free of calcium carbonate. This is probably because calcium carbonate neutralizes an acid gas. It is found that, when strong attention is paid to a NOₓ-decomposing function out of the applications or functions of a fluororesin membrane material, calcium carbonate is preferably added to its dispersion or photocatalyst layer. With such procedure, the NOₓ-decomposing function can be strengthened, or when the NOₓ-decomposing function is constant, the addition amount of the photocatalyst can be suppressed.

### Test Example 3

In Test Example 3, a plurality of kinds of dispersions each containing calcium carbonate were produced in the same manner as in the production of the dispersions each containing calcium carbonate in Test Example 2. Materials used for producing such dispersions are the same as those described in Test Example 2. The total solid content concentration of titanium oxide and the fluororesin in each of the dispersions was adjusted to 25%.

The dispersions produced in Test Example 3 each containing calcium carbonate are each free of the PTEE, and their ratios between the photocatalyst and the FEP are changed. Specifically, the dispersions are 6 kinds, that is, LTi20FEP100, LTi25FEP100, LTi30FEP100, LTi35FEP100, LTi40FEP100, and LTi45FEP100.

Six kinds of test membrane materials were produced by using the 6 kinds of dispersions under the same conditions as those of Test Example 1.

A test for the presence or absence of a crack, and a test for the self-cleaning function of a photocatalyst layer were performed on each of the 6 kinds of test membrane materials under the same conditions as those of Test Example 1, and a test for a NOₓ-decomposing function was performed on each of the test membrane materials under the same conditions as those of Test Example 2. In addition, a test for a long-term adhesive force to be described later was performed on each of the 6 kinds of test membrane materials.

[Presence or Absence of Crack]

The results of the test are shown in Table 6 below.

TABLE 6

| LTi20FEP100 | LTi25FEP100 | LTi30FEP100 | LTi35FEP100 | LTi40FEP100 | LTi45FEP100 |
|---|---|---|---|---|---|
| x | x | x | x | x | x |

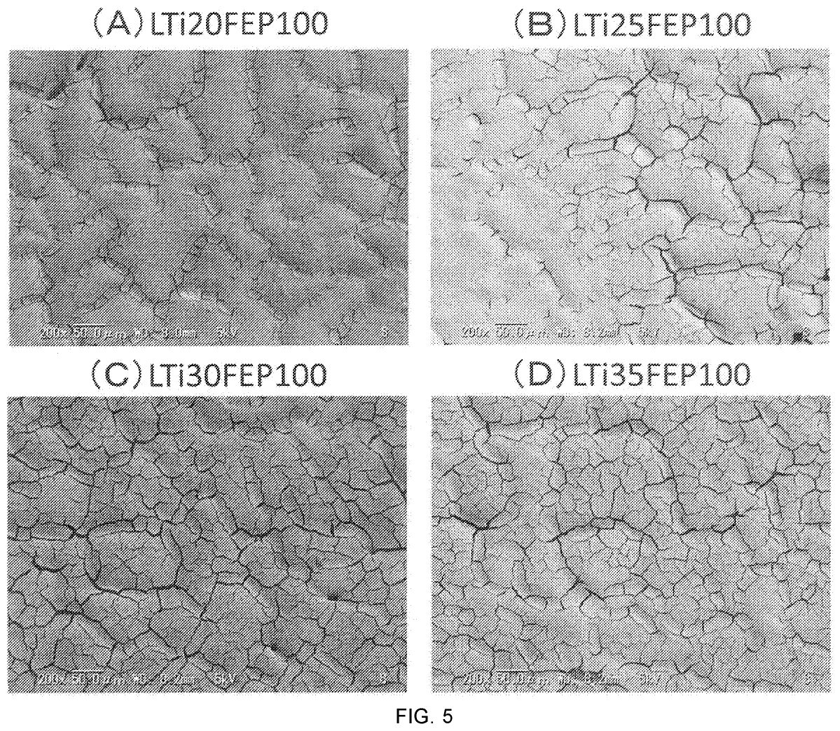

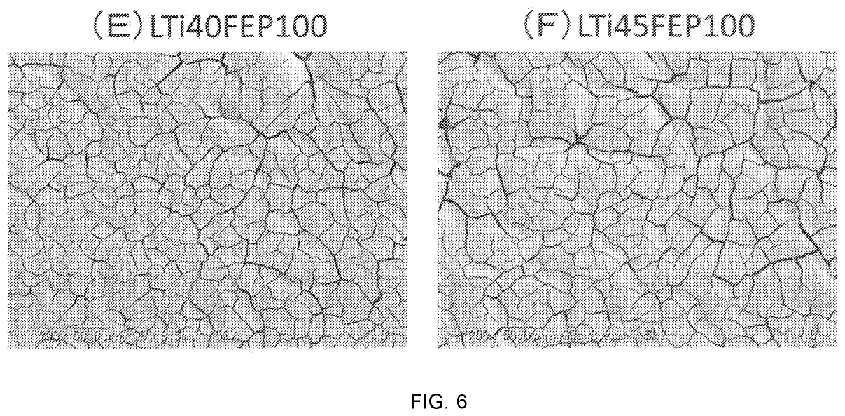

It was found from the foregoing that, when a photocatalyst layer was free of the PTFE, despite the fact that the photocatalyst layer contained calcium carbonate having a crack-reducing effect, and irrespective of the magnitude of the photocatalyst ratio of the layer, a crack occurred in the photocatalyst layer, and hence there was substantially no difference between the layer and the current product (FIG. 5(A) to FIG. 5(D), FIG. 6(E), and FIG. 6(F)).

[Self-cleaning Function]

The results of the evaluation are shown in Table 7.

TABLE 7
Unit: nmol/L/min

| LTi20FEP100 | LTi25FEP100 | LTi30FEP100 | LTi35FEP100 | LTi40FEP100 | LTi45FEP100 |
|---|---|---|---|---|---|
| 25.3 | 24.2 | 26.3 | 26.0 | 25.1 | 25.0 |
| ∘ | ∘ | ∘ | ∘ | ∘ | ∘ |

It was found from the foregoing that, in the case where a photocatalyst layer was free of the PTFE, even when the photocatalyst layer contained calcium carbonate having a crack-reducing effect, the magnitude of the photocatalyst ratio of the layer did not largely affect the self-cleaning ability thereof.

[NOₓ-decomposing Function]

The results of the evaluation are shown in Table 8.

TABLE 8
Unit: μmol

| LTi20FEP100 | LTi25FEP100 | LTi30FEP100 | LTi35FEP100 | LTi40FEP100 | LTi45FEP100 |
|---|---|---|---|---|---|
| 0.31 | 0.40 | 0.60 | 0.80 | 0.95 | — |
| Δ | Δ | ∘ | ∘ | ∘ | — |

It was found from the foregoing that, when a photocatalyst layer was free of the PTFE, and the photocatalyst layer contained calcium carbonate having a crack-reducing effect, its NOₓ-decomposing function was improved with increasing photocatalyst ratio.

[Long-term Adhesive Force]

A test for a long-term adhesive force was performed as described below. Two test membrane materials of each kind were superimposed on each other, and were thermally welded with a hot plate under the conditions of 370° C., 70 seconds, and a pressure of 0.5 kg/cm² under a state in which a FEP film that was a 125-micrometer thick film formed of a FEP was interposed therebetween. The welding was performed in 2 ways. First welding is the thermal welding of photocatalyst layers assuming a so-called double-sided coated product including photocatalyst layers on both surfaces thereof, and second welding is the thermal welding of a photocatalyst layer and a PTFE layer assuming a so-called single-sided coated product including a photocatalyst layer only on one surface thereof.

In each of the cases, after the welding had been performed, the resultant was irradiated with UV light through the use of a super xenon accelerated weathering tester (manufactured by Suga Test Instruments Co., Ltd., SX-75) having an irradiation intensity and a black panel temperature set to 18 mW/cm² (300 nm to 400 nm) and 63±2 (° C.), respectively for 1,000 hours. After that, a rectangular strip having a width of 2 cm and a length of 15 cm was cut out of the resultant, and a T-shaped peel test piece was produced by making a notch in a 5-centimeter range starting from the front end of the strip with a cutter. A peel test was performed at a rate of 50 mm/min, and the adhesive force and external appearance of the test piece at that time were evaluated.

A case in which, as compared to an initial state, an adhesive force retention rate was 80% or more, and a peeled area at an interface between the glass fibers and the fluororesin after the peel test was 80% or more was indicated by Symbol “o”, a case in which the adhesive force retention rate was from 50% to 80%, and the peeled area at the interface between the fibers and the fluororesin after the peel test was from 50% to 80% was indicated by Symbol “Δ”, and a case in which the adhesive force retention rate was 50% or less, and the peeled area at the interface between the fibers and the fluororesin after the peel test was 50% or less was indicated by Symbol “x”.

The results of the evaluation are shown in Table 9.

TABLE 9

| | LTi20 | LTi25 | LTi30 | LTi35 | LTi40 | LTi45 |
|---|---|---|---|---|---|---|
| | FEP100 | FEP100 | FEP100 | FEP100 | FEP100 | FEP100 |
| Double-sided | ○ | ○ | × | × | × | × |
| coated product | | | | | | |
| Single-sided | ○ | ○ | ○ | ○ | Δ | × |
| coated product | | | | | | |

As shown in Table 9, the photocatalyst ratio at which a long-term adhesive property is stabilized in the case of the thermal welding of the photocatalyst layers assuming a double-sided coated product is found to be 25% or less. Meanwhile, the photocatalyst ratio at which the long-term adhesive property is stabilized in the case of the thermal welding of the photocatalyst layer and the PTFE layer assuming a single-sided coated product is found to be 40% or less.

### Test Example 4

In Test Example 4, a plurality of kinds of dispersions each containing calcium carbonate were produced in the same manner as in the production of the dispersions each containing calcium carbonate in Test Example 2. Materials used for producing such dispersions are the same as those described in Test Example 2. The total solid content concentration of titanium oxide and the fluororesins in each of the dispersions was adjusted to 28%.

In the dispersions produced in Test Example 4 each containing calcium carbonate, photocatalyst ratios are changed in 6 stages between 15% and 45%, and FEP ratios are changed in 4 stages between 0% and 60%. Specifically, the dispersions are 24 kinds, that is, LTi15FEP0, LTi18FEP0, LTi20FEP0, LTi25FEP0, LTi35FEP0, LTi45FEP0, LTi15FEP20, LTi18FEP20, LTi20FEP20, LTi25FEP20, LTi35FEP20, LTi45FEP20, LTi15FEP40, LTi18FEP40, LTi20FEP40, LTi25FEP40, LTi35FEP40, LTi45FEP40, LTi15FEP60, LTi18FEP60, LTi20FEP60, LTi25FEP60, LTi35FEP60, and LTi45FEP60.

Twenty-four kinds of test membrane materials were produced by using the 24 kinds of dispersions under the same conditions as those of Test Example 1.

A test for the presence or absence of a crack, and a test for the self-cleaning function of a photocatalyst layer were performed on each of the 24 kinds of test membrane materials under the same conditions as those of Test Example 1, a test for a NOₓ-decomposing function was performed on each of the test membrane materials under the same conditions as those of Test Example 2, and a test for a long-term adhesive force was performed on each of the test membrane materials under the same conditions as those of Test Example 3.

[Presence or Absence of Crack]

The results of the test are shown in Table 10.

In Table 10, the following representation approach is adopted: a photocatalyst ratio in each photocatalyst layer is shown in a horizontal column, a FEP ratio therein is shown in a vertical column, and an evaluation concerning a photocatalyst layer specified by the photocatalyst ratio and the FEP ratio is written in a portion where the columns cross each other. How to read the table is also applicable to the following.

TABLE 10

| | LTi15 | LTi18 | LTi20 | LTi25 | LTi35 | LTi45 |
|---|---|---|---|---|---|---|
| FEP0 | ○ | ○ | ○ | ○ | Δ | Δ |
| FEP20 | ○ | ○ | ○ | ○ | Δ | Δ |
| FEP40 | ○ | ○ | ○ | Δ | Δ | Δ |
| FEP60 | ○ | ○ | ○ | Δ | × | × |

As can be seen from Table 10, when the FEP ratio is reduced to less than about 50%, as long as the photocatalyst ratio is set to 40% or less, the occurrence of a tortoise shell-like crack occurring in the current product can be reduced.

[Self-cleaning Function]

The results of the test are shown in Table 11.

TABLE 11

| | LTi15 | LTi18 | LTi20 | LTi25 | LTi35 | LTi45 |
|---|---|---|---|---|---|---|
| FEP0 | 27.4 | 26.4 | 26.8 | 25.5 | 26.8 | 25.9 |
| Evaluation | ○ | ○ | ○ | ○ | ○ | ○ |
| FEP20 | 27.0 | 26.4 | 27.3 | 25.5 | 26.2 | 26.6 |
| Evaluation | ○ | ○ | ○ | ○ | ○ | ○ |
| FEP40 | 27.1 | 25.9 | 27.5 | 26.4 | 25.8 | 25.7 |
| Evaluation | ○ | ○ | ○ | ○ | ○ | ○ |
| FEP60 | 27.2 | 26.0 | 27.6 | 26.1 | 27.1 | 26.1 |
| Evaluation | ○ | ○ | ○ | ○ | ○ | ○ |

Unit: nmol/L/min

In each photocatalyst layer containing calcium carbonate, the self-cleaning function had no problem.

[NOₓ-decomposing Function]

The results of the test are shown in Table 12.

TABLE 12

| | LTi15 | LTi18 | LTi20 | LTi25 | LTi35 | LTi45 |
|---|---|---|---|---|---|---|
| FEP0 | — | — | — | — | — | — |
| Evaluation | — | — | — | — | — | — |
| FEP20 | [0.40] | [0.50] | — | [0.66] | — | — |
| Evaluation | Δ | ○ | — | ○ | — | — |
| FEP25 | [0.34] | 0.50 | [0.50] | [0.68] | — | — |
| Evaluation | Δ | ○ | ○ | ○ | — | — |
| FEP40 | 0.24 | 0.44 | 0.50 | 0.52 | — | — |
| Evaluation | × | Δ | ○ | ○- | — | — |
| FEP60 | — | — | — | — | — | — |
| Evaluation | — | — | — | — | — | — |
| FEP100 | — | — | [0.31] | [0.4] | [0.80] | — |
| Evaluation | — | — | Δ | Δ | ○ | — |

* The results of Test Example 2 and Test Example 3 were diverted
to the bracketed portions.
Unit: μmol

It is found from Table 12 that, as compared to the case where the FEP ratio is 100%, even under a state in which the addition amount of titanium oxide is reduced, the NOₓ-decomposing function serving as air purification performance can be maintained by reducing the FEP ratio (increasing the ratio of the PTFE to the FEP).

It can be said that, in particular, a photocatalyst layer having a photocatalyst ratio of from 18% to 25% and a FEP ratio of from 20% to 40% is excellent in NOₓ-decomposing function.

[Long-term Adhesive Force]

The results of the test are shown in Table 13. With regard to the test for a long-term adhesive force, only 12 kinds of test membrane materials were used as test objects.

TABLE 13

| | LTi15 | LTi20 | LTi25 | LTi35 | LTi40 | LTi45 |
|---|---|---|---|---|---|---|
| FEP25 | ○ | ○ | Δ | × | × | × |
| Double-sided | | | | | | |
| coated product | | | | | | |
| FEP25 | ○ | ○ | ○ | ○ | Δ | × |
| Single-sided | | | | | | |
| coated product | | | | | | |
| FEP100 | [○] | [○] | [Δ] | [×] | [×] | [×] |
| Double-sided | | | | | | |
| coated product | | | | | | |
| FEP100 | [○] | [○] | [○] | [○] | [Δ] | [×] |
| Single-sided | | | | | | |
| coated product | | | | | | |

* The results of Test Example 3 were diverted to the bracketed
portions.

As shown in Table 13, in each of the case of the thermal welding of the photocatalyst layers assuming a double-sided coated product, and the case of the thermal welding of the photocatalyst layer and a FEP layer free of any photocatalyst and formed only of the FEP, the thermal welding assuming a single-sided coated product, even when there was a difference in FEP ratio, a large difference in long-term adhesive force did not appear. Meanwhile, in each of the case of the thermal welding of the photocatalyst layers assuming a double-sided coated product, and the case of the thermal welding of the photocatalyst layer and the FEP layer assuming a single-sided coated product, the magnitude of the photocatalyst ratio affected the stability of the long-term adhesive force. In other words, the following result was obtained: the long-term adhesive force was determined by the photocatalyst ratio rather than by the FEP ratio. It was found that, irrespective of the magnitude of the FEP ratio, the photocatalyst ratio at which a long-term adhesive property was stabilized in the case of the thermal welding of the photocatalyst layer and the PTFE layer assuming a double-sided coated product was 25% or less, and the photocatalyst ratio at which the long-term adhesive property was stabilized in the case of the thermal welding of the photocatalyst layer and the FEP layer assuming a single-sided coated product was 40% or less.

The same test results were obtained even when the membrane to be interposed between both the test membrane materials was changed from the FEP film to a PFA film formed of a tetrafluoroethylene-perfluoroalkyl vinyl ether copolymer (PFA).

### Test Example 5

In Test Example 5, a plurality of kinds of dispersions each containing calcium carbonate were produced in the same manner as in the production of the dispersions each containing calcium carbonate in Test Example 2. Materials used for producing such dispersions are the same as those described in Test Example 2. The total solid content concentration of titanium oxide and the fluororesins in each of the dispersions was adjusted to 28%.

The dispersions to be produced in Test Example 5 are basically 2 kinds, that is, the LTi15FEP25 and the LTi20FEP25. In Test Example 5, however, such a dispersion as described below was produced: an aqueous slurry containing 30% of a bluish inorganic pigment (cobalt blue) was added to each of the 2 kinds of dispersions at a ratio of 1% or 3% with respect to the weight of the dispersion before its addition (0.6% or 0.9% in terms of the solid content addition weight ratio of the inorganic pigment). In other words, the total number of kinds of dispersions in Test Example 5 is 4. A representation like “LTi15FEP25P1” is used for distinguishing those dispersions. The partial representation “LTi15FEP25” in such representation has the same meaning as before, and the end representation “P1” means that the aqueous slurry of the bluish inorganic pigment is added to a dispersion specified by the representation “LTi15FEP25” in front thereof at a ratio of 1% with respect to the weight of the dispersion. Similarly, when the aqueous slurry of the bluish inorganic pigment is added at a ratio of 3% with respect to the weight of the dispersion, the representation “P3” is added to the end of the representation “LTi15FEP25”.

In other words, the dispersions produced in Test Example 5 are LTi15FEP25P1, LTi20FEP25P1, LTi15FEP25P3, and LTi20FEP25P3.

Four kinds of test membrane materials were produced by using the 4 kinds of dispersions under the same conditions as those of Test Example 1.

A test for the self-cleaning function of a photocatalyst layer was performed on each of the 4 kinds of test membrane materials under the same conditions as those of Test Example 1, a test for a NOₓ-decomposing function was performed on each of the test membrane materials under the same conditions as those of Test Example 2, and a test for a long-term adhesive force was performed on each of the test membrane materials under the same conditions as those of Test Example 3.

[Self-cleaning Function]

The results of the test are shown in Table 14.

TABLE 14
Unit: nmol/L/min

| LTi15FEP25P1 | LTi15FEP25P3 | LTi20FEP25P1 | LTi20FEP25P3 |
|---|---|---|---|
| 25.2 | 27.3 | 28.0 | 25.3 |
| ∘ | ∘ | ∘ | ∘ |

In each case, the self-cleaning function was satisfactory. Although comparison between the case where the addition of the inorganic pigment is present and the case where the addition is absent can be performed by comparing Table 14 and Table 4, the self-cleaning function is rather improved when the inorganic pigment is present.

[NOₓ-decomposing Function]

The results of the test are shown in Table 15.

TABLE 15
Unit: μmol

| LTi15FEP25P1 | LTi15FEP25P3 | LTi20FEP25P1 | LTi20FEP25P3 |
|---|---|---|---|
| 0.48 | 0.43 | 0.72 | 0.52 |
| Δ | Δ | ∘ | ∘ |

It was found that the evaluation of the NOₓ-decomposing function did not depend on the amount of the inorganic pigment, but instead depended on the photocatalyst ratio. Comparison between the case where the addition of the inorganic pigment was present and the case where the addition was absent was able to be performed by comparing Table 15 and Table 5, and the following result was obtained: the presence of the inorganic pigment did not adversely affect NOₓ-removing performance.

[Long-term Adhesive Force]

The results of the test are shown in Table 16.

TABLE 16

| | LTi15FEP25P1 | LTi15FEP25P3 | LTi20FEP25P1 | LTi20FEP25P3 |
|---|---|---|---|---|
| Single-sided coated product | ∘ | ∘ | ∘ | ∘ |
| Double-sided coated product | ∘ | ∘ | ∘ | ∘ |

As shown in Table 16, it was confirmed that no adverse effect due to the addition of the inorganic pigment occurred in each of the case of the thermal welding of the photocatalyst layers assuming a double-sided coated product, and the case of the thermal welding of the photocatalyst layer and the PTFE layer assuming a single-sided coated product. In particular, the fact is further clarified by comparing Table 16 and Table 13.

### Test Example 6

In Test Example 6, a plurality of kinds of dispersions each containing calcium carbonate were produced in the same manner as in the production of the dispersions each containing calcium carbonate in Test Example 2. Materials used for producing such dispersions are basically the same as those described in Test Example 2. The total solid content concentration of titanium oxide and the fluororesins in each of the dispersions was adjusted to 28%.

The dispersions to be produced in Test Example 6 are basically only 1 kind, that is, the LTi20FEP25. In Test Example 6, however, 3 kinds of dispersions different from one another in amount of calcium carbonate (manufactured by Kishida Chemical Co., Ltd., product number: 000-13435) to be added to the 1 kind of dispersion were produced. The addition amounts of calcium carbonate in the respective dispersions are 0%, 10%, and 20% with respect to the weight of the photocatalyst. In this test example, a number corresponding to the weight (%) of calcium carbonate with respect to the weight of the photocatalyst is attached to the beginning of the symbol “LTi20FEP25”, and the 3 kinds of dispersions are represented as 0LTi20FEP25, 10LTi20FEP25, and 20LTi20FEP25, respectively.

Three kinds of test membrane materials were produced by using the 3 kinds of dispersions under the same conditions as those of Test Example 1.

A test for the self-cleaning function of a photocatalyst layer was performed on each of the 3 kinds of test membrane materials under the same conditions as those of Test Example 1, and a test for a NOₓ-decomposing function was performed on each of the test membrane materials under the same conditions as those of Test Example 2.

[Self-cleaning Function]

The results of the test are shown in Table 17.

TABLE 17
Unit: nmol/L/min

| 0LTi20FEP25 | 10LTi20FEP25 | 20LTi20FEP25 |
|---|---|---|
| 25.8 | 28.4 | 28 |
| ∘ | ∘ | ∘ |

In each case, the self-cleaning function was satisfactory. In addition, the self-cleaning function when calcium carbonate was present was improved as compared to that when calcium carbonate was absent, but in the case where the weight of calcium carbonate exceeded 10% with respect to the weight of the photocatalyst, a significant improvement in self-cleaning function was not observed.

[NOₓ-decomposing Function]

The results of the test are shown in Table 18.

TABLE 18
Unit: μmol

| 0LTi20FEP25 | 10LTi20FEP25 | 20LTi20FEP25 |
|---|---|---|
| 0.4 | 0.7 | 0.42 |
| Δ | ∘ | Δ |

Although the NOₓ-decomposing function when calcium carbonate was present was improved as compared to that when calcium carbonate was absent, in the case where the weight of calcium carbonate exceeded 10% with respect to the weight of the photocatalyst to reach 20%, the NOₓ-decomposing function was substantially the same as that in the case where calcium carbonate was absent. Therefore, when attention is paid to the NOₓ-decomposing function, the addition of calcium carbonate in a weight of more than 10% with respect to the weight of the photocatalyst has no meaning.

### Test Example 7

In Test Example 7, a plurality of kinds of dispersions each of which was free of calcium carbonate were produced by the same method as that of Test Example 1, and a plurality of kinds of dispersions each containing calcium carbonate were produced by the same method as that of Test Example 6.

In Test Example 7, 25 kinds of dispersions were produced. In all the dispersions, ratios between the FEP and the PTFE in the fluororesins in photocatalyst layers to be finally obtained were allowed to have a constant value of 25:75 (i.e., FEP ratios were allowed to be 25%). In addition, ratios between the photocatalyst and calcium carbonate in the respective dispersions were changed. Specifically, the weight ratios of titanium oxide in the photocatalyst layers to the photocatalyst layers to be finally obtained when the respective dispersions were used were allowed to change between 15% and 40%, and calcium carbonate was added so that the weight ratios of calcium carbonate to titanium oxide changed between 0% and 25%. The total solid content concentration of titanium oxide and the fluororesins in each of the dispersions was adjusted to 28%.

Of the produced dispersions, 5 kinds were each free of calcium carbonate, and 20 kinds each contained calcium carbonate. As a result, the 25 kinds of dispersions were produced.

The list of the produced dispersions is described below. A portion concerning a FEP ratio is omitted in a symbol in the following list because all the FEP ratios in the following dispersions are 25%. In addition, the symbol “Ca˜” representing the ratio (%) of the weight of calcium carbonate to the weight of the titanium oxide photocatalyst is attached to the head of each of the following symbols. For example, the symbol “Ca5Ti15” represents the following contents: a dispersion that contains calcium carbonate in a weight of 5% with respect to the weight of titanium oxide, and has a photocatalyst ratio of 15% and a FEP ratio of 25%.

The 25 kinds of dispersions produced in Test Example 7 are described by the foregoing representation method as follows: Ca0Ti15, Ca5Ti15, Ca10Ti15, Ca20Ti15, Ca25Ti15, Ca0Ti20, Ca5Ti20, Cal0Ti20, Ca20Ti20, Ca25Ti20, Ca0Ti25, Ca5Ti25, Cal0Ti25, Ca20Ti25, Ca25Ti25, Ca0Ti30, Ca5Ti30, Cal0Ti30, Ca20Ti30, Ca25Ti30, Ca0Ti40, Ca5Ti40, Cal0Ti40, Ca20Ti40, and Ca25Ti40.

Next, 25 kinds of test membrane materials were produced by using the 25 kinds of dispersions under the same conditions as those of Test Example 1.

A test for a NOₓ-decomposing function was performed on each of the 25 kinds of test membrane materials under the same conditions as those of Test Example 2, and a test for a long-term adhesive force was performed on each of the test membrane materials under the same conditions as those of Test Example 3.

[NOₓ-decomposing Function/Long-term Adhesive Force]

The results of the test for a NOₓ-decomposing function and the test for a long-term adhesive force are collectively shown in Table 19.

In Table 19, the following representation approach is adopted: a photocatalyst ratio in each photocatalyst layer is shown in a vertical column, the ratio (%) of the weight of calcium carbonate to the weight of the titanium oxide photocatalyst therein is shown in a horizontal column, and an evaluation concerning a photocatalyst layer specified by the photocatalyst ratio and the ratio (%) of the weight of calcium carbonate to the weight of the titanium oxide photocatalyst is written in a portion where the columns cross each other.

A numerical value shown in an upper stage in a column free of the letter “Evaluation” in the vertical columns of Table 19 represents a NOₓ-decomposing function (unit: μmol). In addition, the letter “Adhesion o”, “Adhesion Δ”, or “Adhesion x” shown in a lower stage in a column free of the letter “Evaluation” in the vertical columns of Table 19 represents long-term adhesive performance. The long-term adhesive performance in this case is long-term adhesive performance in a single-sided coated product. In addition, Symbol “o”, “Δ”, or “x” in a column including the letter “Evaluation” in the vertical columns of Table 19 represents the comprehensive evaluation of the NOₓ-decomposing function and long-term adhesive force of a fluororesin membrane material including the photocatalyst layer, and the comprehensive evaluation is performed as follows: after each of the NOₓ-decomposing function and the long-term adhesive force has been indicated by any one of the three symbols, that is, “o”, “Δ”, and “x”, when the evaluations of the two items coincide with each other, the coinciding evaluation is shown, and when the evaluations of the two items are different from each other, the worse evaluation is shown.

TABLE 19

| | Ca0 | Ca5 | Ca10 | Ca20 | Ca25 |
|---|---|---|---|---|---|
| Ti15 | 0.15 | 0.25 | 0.32 | 0.27 | 0.17 |
| | Adhesion ∘ | Adhesion ∘ | Adhesion ∘ | Adhesion ∘ | Adhesion ∘ |
| Ti15 evaluation | x | Δ | Δ | Δ | x |
| Ti20 | 0.25 | 0.41 | 0.55 | 0.35 | 0.20 |
| | Adhesion ∘ | Adhesion ∘ | Adhesion ∘ | Adhesion ∘ | Adhesion ∘ |
| Ti20 evaluation | Δ | Δ | ∘ | Δ | x |
| Ti25 | 0.34 | 0.55 | 0.72 | 0.42 | 0.24 |
| | Adhesion ∘ | Adhesion ∘ | Adhesion ∘ | Adhesion ∘ | Adhesion ∘ |
| Ti25 evaluation | Δ | ∘ | ∘ | Δ | x |
| Ti30 | 0.48 | 0.65 | 0.93 | 0.64 | 0.42 |
| | Adhesion ∘ | Adhesion ∘ | Adhesion ∘ | Adhesion Δ | Adhesion Δ |
| Ti30 evaluation | Δ | ∘ | ∘ | Δ | Δ |
| Ti40 | 0.90 | 0.93 | 0.95 | 0.85 | 0.62 |
| | Adhesion Δ | Adhesion Δ | Adhesion x | Adhesion x | Adhesion x |
| Ti40 evaluation | Δ | Δ | x | x | x |

### Test Example 8

In Test Example 8, a plurality of kinds of dispersions each containing calcium carbonate were produced by the same method as that of Test Example 6, and a plurality of kinds of dispersions each containing calcium carbonate and an inorganic pigment were produced by the same method as that of Test Example 5.

In Test Example 8, 24 kinds of dispersions were produced. In all the dispersions, ratios between the FEP and the PTFE in the fluororesins in photocatalyst layers to be finally obtained were allowed to have a constant value of 25:75 (i.e., FEP ratios were allowed to be 25%). In addition, the addition amount of calcium carbonate in each of the dispersions was fixed to 10% with respect to the weight of the photocatalyst. In addition, the ratios (total amounts) of the inorganic pigment to titanium oxide and calcium carbonate in the respective dispersions were changed. Specifically, the ratios of titanium oxide in the photocatalyst layers to be finally obtained when the respective dispersions were used were allowed to change between 15% and 40%, and calcium carbonate was added so that the ratios of the weights of calcium carbonate in the photocatalyst layers changed between 0% and 25% with respect to the weight of titanium oxide. The total solid content concentration of titanium oxide and the fluororesins in each of the dispersions was adjusted to 28%.

Of the produced dispersions, 6 kinds each contained only calcium carbonate in addition to the photocatalyst and the fluororesins, and 18 kinds each contained calcium carbonate and the inorganic pigment in addition to the photocatalyst and the fluororesins. As a result, the 24 kinds of dispersions were produced. The list of the produced dispersions is described below. A portion concerning a FEP ratio is omitted in a symbol in the following list because all the FEP ratios in the following dispersions are 25%. In addition, description concerning the addition amount of calcium carbonate is also omitted in a symbol in the following list because all the weights of calcium carbonate in the following dispersions are 10% with respect to the weight of the photocatalyst. In addition, the symbol “P˜” representing at what percentage a dispersion contains an aqueous slurry containing 30% of a bluish inorganic pigment (cobalt blue) with respect to the weight of the dispersion before its addition is attached to the end of each of the following symbols. For example, the symbol “LTi15P1” represents the following contents: a dispersion that contains calcium carbonate in a weight of 10% with respect to the weight of titanium oxide, that has a photocatalyst ratio of 15% and a FEP ratio of 25%, and that contains the aqueous slurry containing 30% of the inorganic pigment at a ratio of 1% with respect to the weight of the dispersion before its addition.

The 24 kinds of dispersions produced in Test Example 8 are described by the foregoing representation method as follows: LTi15P0, LTi15P1, LTi15P3, LTi15P5, LTi20P0, LTi20P1, LTi20P3, LTi20P5, LTi25P0, LTi25P1, LTi25P3, LTi25P5, LTi30P0, LTi30P1, LTi30P3, LTi30P5, LTi35P0, LTi35P1, LTi35P3, LTi35P5, LTi40P0, LTi40P1, LTi40P3, and LTi40P5.

Next, 24 kinds of test membrane materials were produced by using the 24 kinds of dispersions under the same conditions as those of Test Example 1.

A test for a NOₓ-decomposing function was performed on each of the 24 kinds of test membrane materials, and a test for a long-term adhesive force was performed on each of the test membrane materials under the same conditions as those of Test Example 3.

A test for a long-term adhesive force in the case where a single-sided coated product was assumed and that in the case where a double-sided coated product was assumed were performed on each of the 24 kinds of test membrane materials under the same conditions as those of Test Example 3.

[Long-term Adhesive Force]

The results of the test for a long-term adhesive force are shown in each of Table 20 and Table 21. The results of the test for a long-term adhesive force in the case where a double-sided coated product is assumed are shown in Table 20, and the results of the test for a long-term adhesive force in the case where a single-sided coated product is assumed are shown in Table 21.

In each of Table 20 and Table 21, the following representation approach is adopted: a photocatalyst ratio in each photocatalyst layer is shown in a horizontal column, and the ratio of the inorganic pigment in each photocatalyst layer is shown in a vertical column, and an evaluation concerning a photocatalyst layer specified by the photocatalyst ratio and the ratio of the inorganic pigment is written in a portion where the columns cross each other.

TABLE 20

| | LTi15 | LTi20 | LTi25 | LTi30 | LTi35 | LTi40 |
|---|---|---|---|---|---|---|
| P0 | ○ | ○ | Δ | × | × | × |
| P1 | ○ | ○ | Δ | × | × | × |
| P3 | ○ | ○ | × | × | × | × |
| P5 | ○ | Δ | × | × | × | × |

TABLE 21

| | LTi15 | LTi20 | LTi25 | LTi30 | LTi35 | LTi40 |
|---|---|---|---|---|---|---|
| P0 | ○ | ○ | ○ | ○ | ○ | Δ |
| P1 | ○ | ○ | ○ | ○ | ○ | Δ |
| P3 | ○ | ○ | ○ | ○ | ○ | × |
| P5 | ○ | ○ | ○ | ○ | Δ | × |

1. A method of producing a fluororesin membrane material by forming a photocatalyst layer containing a photocatalyst and fluororesins on at least one outermost surface of a fluororesin layer containing a polytetrafluoroethylene (PTFE) as a fluororesin, the method comprising:
applying a dispersion containing the photocatalyst and the fluororesins to at least one outermost surface of the fluororesin layer;
drying the dispersion;
calcining the fluororesin layer having applied thereto the dispersion at a temperature equal to or more than a melting point of any fluororesin of the fluororesins incorporated into the dispersion; and
cooling the calcined fluororesin layer having applied thereto the dispersion to room temperature,
wherein the photocatalyst and the fluororesins in the dispersion to be applied to the fluororesin layer satisfy a photocatalyst ratio, which is a ratio of a weight of the photocatalyst to a total weight of the photocatalyst and the fluororesins, of 40% or less,
wherein the fluororesins in the dispersion to be applied to the fluororesin layer are formed of the PTFE and a second specific fluororesin that is a fluorinated resin copolymer having a melting point of 240° C. or more and a continuous use temperature of 200° C. or more, and
wherein the specific fluororesin and the PTFE in the dispersion satisfy a specific fluororesin ratio, which is a ratio of a weight of the specific fluororesin to a total weight of the specific fluororesin and the PTFE, of between 10% and 50%, both inclusive.

2. The method of claim 1, wherein the produced fluororesin membrane material is a final product.

3. The method of claim 2, further comprising, due to the photocatalyst ratio and the specific fluororesin ratio, reducing occurrence of tortoise shell-like cracks in the photocatalyst layer while still permitting thermal welding of the produced fluororesin membrane material.

4. The method of claim 1, wherein after the cooling, a photocatalyst ratio of the photocatalyst layer is the same as the photocatalyst ratio of the dispersion, and a specific fluororesin ratio of the photocatalyst layer is the same as the specific fluororesin ratio of the dispersion.

5. The method of claim 1, wherein the calcining is completed without applying a shear stress, and wherein due to the applying, the drying, the calcining, and the cooling, the photocatalyst layer is not fibrillated.

6. The method of claim 1, further comprising melting both the PTFE and the specific fluororesin in the dispersion at the time of the calcining.

7. The method of claim 1, further comprising using the fluororesin membrane material in a roof of architecture.

8. The method of claim 1, further comprising:
cutting the fluororesin membrane material into a first part and a second part; and
thermally welding the first part to the second part.

9. The method of claim 8, wherein the fluororesin membrane material comprises a single-sided coated product in which the photocatalyst layer is applied to only one outermost surface of the fluororesin layer.

10. The method of claim 8, wherein the fluororesin membrane material comprises a double-sided coated product in which the photocatalyst layer is applied to a first outermost surface of the fluororesin layer and to a second outermost surface of the fluororesin layer opposite to the first outermost surface, and,
wherein the photocatalyst and the fluororesins in the dispersion to be applied to the fluororesin layer satisfy a photocatalyst ratio of 25% or less.

11. The method of claim 1, further comprising, due to the specific fluororesin ratio, reducing cracks occurring in the photocatalyst layer while also permitting thermal welding of the fluororesin membrane material.

12. The method of claim 1, wherein the photocatalyst ratio is 25% or less.

13. The method of claim 1, wherein the photocatalyst ratio is 15% or more.

14. The method of claim 1, wherein the specific fluororesin ratio is between 10% and 30%, both inclusive.

15. The method of claim 1, wherein the specific fluororesin is at least one of a FEP or a PFA.

16. The method of claim 1, further comprising including in the photocatalyst layer a carbonate.

17. The method of claim 16, wherein a weight of the carbonate in the photocatalyst layer is between 20 wt % and 5 wt %, both inclusive, with respect to the weight of the photocatalyst in the photocatalyst layer.

18. The method of claim 16, wherein a total weight of the photocatalyst and the carbonate in the photocatalyst layer is 40% or less with respect to a total weight of the photocatalyst, the carbonate, and the fluororesins in the photocatalyst layer.

19. The method of claim 16, further comprising including in the photocatalyst layer an inorganic pigment for coloring the photocatalyst layer, wherein a total weight of the photocatalyst, the carbonate, and the inorganic pigment in the photocatalyst layer is 40% or less with respect to a total weight of the photocatalyst, the carbonate, the inorganic pigment, and the fluororesins in the photocatalyst layer.

20. A method of producing a fluororesin membrane material, the method comprising:
applying a dispersion containing a photocatalyst and fluororesins to at least one outermost surface of a fluororesin layer containing a polytetrafluoroethylene (PTFE) as a fluororesin,
wherein the photocatalyst and the fluororesins in the dispersion to be applied to the fluororesin layer satisfy a photocatalyst ratio, which is a ratio of a weight of the photocatalyst to a total weight of the photocatalyst and the fluororesins, of 40% or less,
wherein the fluororesins in the dispersion to be applied to the fluororesin layer are formed of the PTFE and a second specific fluororesin that is a fluorinated resin copolymer having a melting point of 240° C. or more and a continuous use temperature of 200° C. or more, and
wherein the specific fluororesin and the PTFE in the dispersion satisfy a specific fluororesin ratio, which is a ratio of a weight of the specific fluororesin to a total weight of the specific fluororesin and the PTFE, of between 10% and 50%, both inclusive;
drying the dispersion;
calcining the fluororesin layer having applied thereto the dispersion at a temperature equal to or more than a melting point of any fluororesin of the fluororesins incorporated into the dispersion; and
cooling the calcined fluororesin layer having applied thereto the dispersion to room temperature,
thereby forming the fluororesin membrane material as a final product with a photocatalyst layer containing the photocatalyst and the fluororesins on the at least one outermost surface of the fluororesin layer.
